(19) United States
(12) Patent Application Publication
(10) Pub. No.: US 2015/0160728 A1
(43) Pub. Date: Jun. 11, 2015

(54) ELECTRONIC DEVICE

(71) Applicant: NIKON CORPORATION, Tokyo (JP)

(72) Inventor: Takeshi YAGI, Tokyo (JP)

(73) Assignee: NIKON CORPORATION, Tokyo (JP)

(21) Appl. No.: 14/533,481

(22) Filed: Nov. 5, 2014

Related U.S. Application Data
(63) Continuation of application No. PCT/JP2013/062913, filed on May 8, 2013.

(30) Foreign Application Priority Data
May 8, 2012 (JP) 2012-106716

(51) Int. Cl. G06F 3/01

(52) U.S. Cl. CPC G06F 3/016

(57) ABSTRACT

An electronic device includes: a display portion configured to display an image; a vibration portion configured to vibrate a body based on vibration control information; and a vibration control information generating portion configured to extract an object from an image and to generate the vibration control information according to the extracted object.

### CROSS-REFERENCE TO RELATED APPLICATION

This is a Continuation application of International Application No. PCT/JP 2013/062913, filed May 8, 2013, which claims priority to Japanese Patent Application No. 2012-106716 filed on May 8, 2012. The contents of the aforementioned applications are incorporated herein by reference.

### BACKGROUND

1. Field of the Invention

The present invention relates to an electronic device.

2. Description of Related Art

A conventionally known portable communication terminal (for example, refer to Japanese Unexamined Patent Application, First Publication No. 2009-136031) includes a display means for displaying an image and an oscillating means for oscillating to a body.

### SUMMARY

However, the oscillation means which is disclosed in Japanese Unexamined Patent Application, First Publication No. 2009-136031 is a mere report means, there is a problem that it is not possible to vibrate the body in accordance with a display image.

The electronic device according to an aspect of the present invention is characterized by including a display portion for displaying an image, a vibration portion configured to vibrate the body based on a vibration control information, and a vibration control information generating portion to extract the object from the image and to generate the vibration control information according to the object extracted.

According to an aspect of the present invention, it is possible to vibrate the body in accordance with the display image.

### BRIEF DESCRIPTION OF THE DRAWINGS

FIG. 1 is an example of a functional block diagram of an electronic device according to a first embodiment of the present invention.

FIG. 2 is an example of a functional block diagram of the vibration control information generating portion.

FIG. 3A is an example of information stored in the vibration pattern information storing portion.

FIG. 3B is an example of information stored in the vibration pattern information storing portion.

FIG. 4 is an explanatory diagram for explaining the vibration pattern information.

FIG. 5A is an example of a flowchart showing a flow of processing of the electronic device.

FIG. 5B is an example of a flowchart showing a flow of processing of the electronic device.

FIG. 6 is an example of a functional block diagram of an electronic device according to a second embodiment of the present invention.

FIG. 7A is an example of information stored in the image storage portion.

FIG. 7B is an example of information stored in the image storage portion.

FIG. 8 is an example of a functional block diagram of the vibration control information generating portion.

FIG. 9A is an example of a flowchart showing a flow of processing of the electronic device.

FIG. 9B is an example of a flowchart showing a flow of processing of the electronic device.

### DESCRIPTION OF EMBODIMENTS

### The First Embodiment

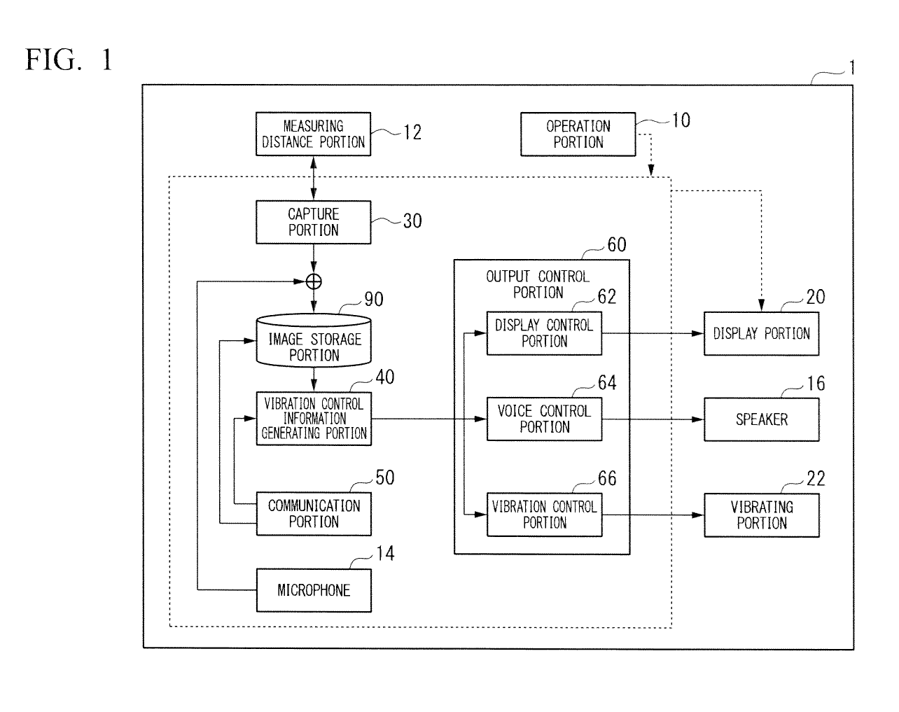

Hereinbelow, an embodiment of the present invention will be described with reference to the drawings. FIG. 1 is an example of a functional block diagram of the electronic device 1 according to a first embodiment of the present invention. The electronic device 1 generates vibration control information to be described later at the time of reproduction.

The electronic device 1, as shown in FIG. 1, includes an operation portion 10, a measuring distance portion 12, a microphone 14, a speaker 16, a display portion 20, a capture portion 30, a vibration control information generating portion 40, a communication portion 50, an output control portion 60, and, an image storage portion 90. The output control portion 60 includes a display control portion 62, a sound control portion 64, and a vibration control portion 66.

The operation portion 10 accepts a user operation. An example of the operation portion 10 is a variety of buttons arranged in a body (a main body, a case body) and a variety of buttons displayed on the display portion 20. The operation portion 10 outputs a user instruction to the microphone 14, the capture portion 30, the vibration control information generating portion 40, the communication portion 50, the output control portion 60, and the image storage unit 90. For example, the operation portion 10 outputs a reproduction instruction to the output control portion 60 on receiving a user operation of instructing a reproduction of image.

The capture portion 30 is, for example, a camera unit. The capture portion 30 captures an object on the basis of an instruction from the user and generates a captured image. For example, the capture portion 30 captures the object with focusing based on the distance to the object measured by the measuring distance portion 12. In addition, in the example of FIG. 1, the electronic device 1 has the measuring distance portion 12 in addition to the capture portion 30. However, the measuring distance portion 12 can be a part of the capture portion 30.

In one example, the measuring distance portion 12 measures the distance to the object based on the instruction from the capture portion 30.

As a measuring method of a distance with the measuring distance portion 12, it is not particularly limited, for example, the distance can be measured by using a laser, or the distance can be measured by using an autofocus (e.g., a contrast method, a phase difference method). In addition, as described above, the measuring distance portion 12 can be a part of the capture portion 30.

The image storage portion 90 stores still images. The still image stored in the image storage portion 90 is, for example, still image obtained from the capture portion 30 (also referred to as captured still image thereinafter) and still image (also referred to as received still image thereinafter) that the communication portion 50 obtains from an external portion (for example, a server on network, an external storage medium).

In addition, the image storage portion 90 stores moving images (video only/video+audio). The moving image (movie) stored in the image storage portion 90 is, for example, moving image obtained from the capture portion 30 and the microphone 14 (also referred to as captured moving image thereinafter) and moving image (also referred to as received moving image thereinafter) that the communication portion 50 obtains from an external portion.

In addition, the image storage portion 90 stores sounds (for example, sound, voice, music). The sound stored in the image storage portion 90 is, for example, sound obtained from the microphone 14 (also referred to as recorded sound thereinafter) and sound (also referred to as received sound thereinafter) that the communication portion 50 is obtained from an external portion.

The communication portion 50 communicates with an external portion (for example, a server on network, an external storage medium).

For example, the communication portion 50 receives the still image (received still image), the moving image (received moving image), and the sound (received sound) from the external portion. In addition, the communication portion 50 receives vibration pattern information (described below). The microphone 14 obtains sound (information).

The vibration control information generating portion 40 extracts an object from an image, which is displayed (or an image which is to be displayed), while the image is displayed (during reproduction) by the display portion 20. The vibration control information generating portion 40 generates (makes, creates) the vibration control information according to the extracted object.

Specifically, when the vibration control information generating portion 40 reproduces the images stored in the image storage portion 90 (still images/moving images), the vibration control information generating portion 40 extracts an object from a reproduced image (image to be reproduced) and generates the vibration control information according to the extracted object. In addition, the vibration control information generating portion 40 outputs the vibration control information generated as described above in the output control portion 60 with the reproduced image.

The vibration control information is the control information for vibrating the vibrating portion 22. In addition, the vibration control information generating portion 40 will be described later in detail.

The display control portion 62 obtains the images stored in the image storage portion 90 (still images/moving images) from the vibration control information generating portion 40. The display control portion 62 controls the output to the display portion 20. The display portion 20 displays an image stored in the image storage portion 90 in accordance with the control of the display control portion 62. The display control portion 62 can control the output to the display portion 20 with respect to through image that is obtained by the capture portion 30.

The sound control portion 64 obtains the sounds stored in the image storage portion 90 (including sound part of moving image) from the vibration control information generating portion 40 and controls the output to the speaker 16. The Speaker 16 outputs a sound stored in the image storage portion 90 in accordance with the control of the sound control portion 64.

The vibration control portion 66 vibrates the vibrating portion 22 based on the vibration control information outputted from the vibration control information generating portion 40. The vibrating portion 22 vibrates the body in accordance with the control of the vibration control portion 66. In other words, the vibrating portion 22 vibrates the body based on the vibration control information generated by the vibration control information generating portion 40 during the image display by the display portion 20. An example of the vibrating portion 22 is a vibration motor.

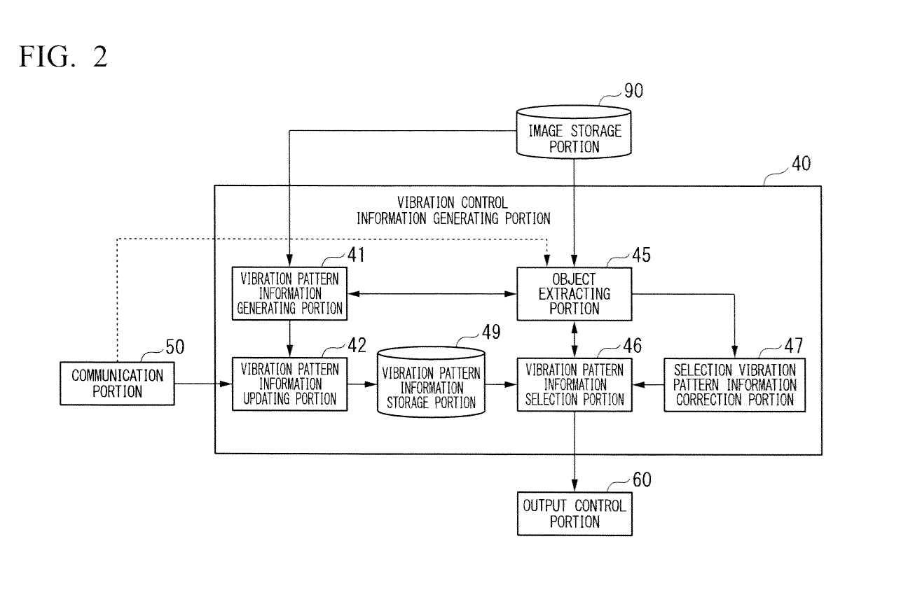

FIG. 2 is an example of a functional block diagram of the vibration control information generating portion 40. As shown in FIG. 2, the vibration control information generating portion 40 includes a vibration pattern information generating portion 41, a vibration pattern information updating portion 42, an object extracting portion 45, a vibration pattern information selection portion 46, a selected vibration pattern information correction portion 47, and a vibration pattern information storage portion 49.

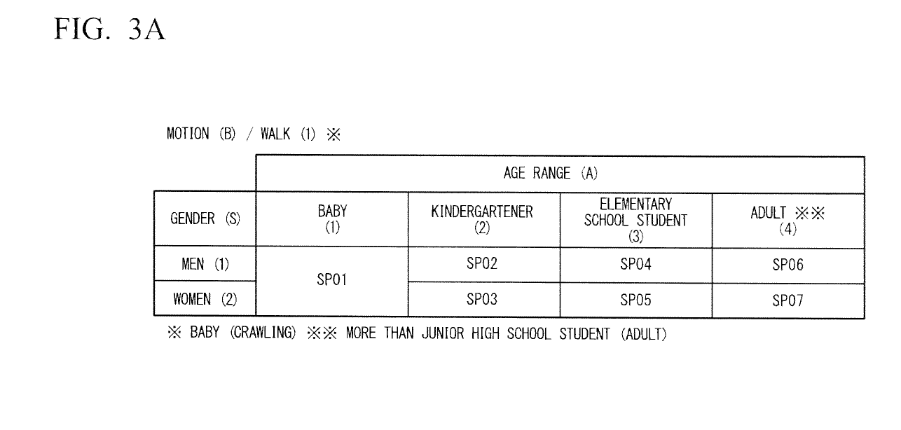

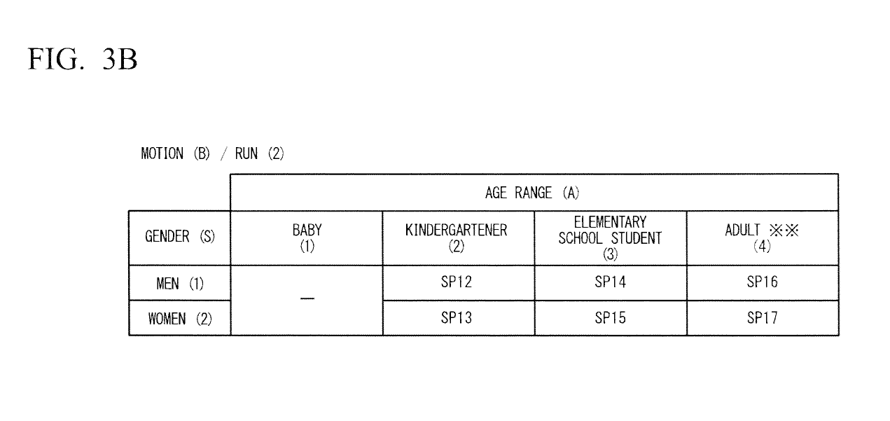

FIGS. 3A and 313 are for an example of information stored in the vibration pattern information storing portion 49.

The vibration pattern information storage portion 49 stores predetermined vibration pattern information for each object. The vibration pattern information is underlying information of the vibration control information. Specifically, the electronic device 1 directly uses the vibration pattern information as the vibration control information. Alternatively, the electronic device 1 uses modified (processed) vibration pattern information as the vibration control information.

Specifically, the vibration pattern information storage portion 49 stores the predetermined vibration pattern information according to the person attribute. For example, as shown in FIGS. 3A and 3B, the vibration pattern information storage portion 49 stores the vibration pattern information (SP01 to SP17) in association with the index “Motion (B)-Gender (S)-Age Range (A)”.

In FIG. 3A, “walk (B=1)” as an item of Motion indicates vibration pattern information (SP01, SP02, SP03, SP04, SP05, SP06, SP07) used for a state where a person is walking (in the case of a baby, for a state of crawling). In FIG. 3B, “run (B=2)” as an item of Motion indicates vibration pattern information (SP12, SP13, SP14, SP15, SP16, SP17) used for a state where a person is running.

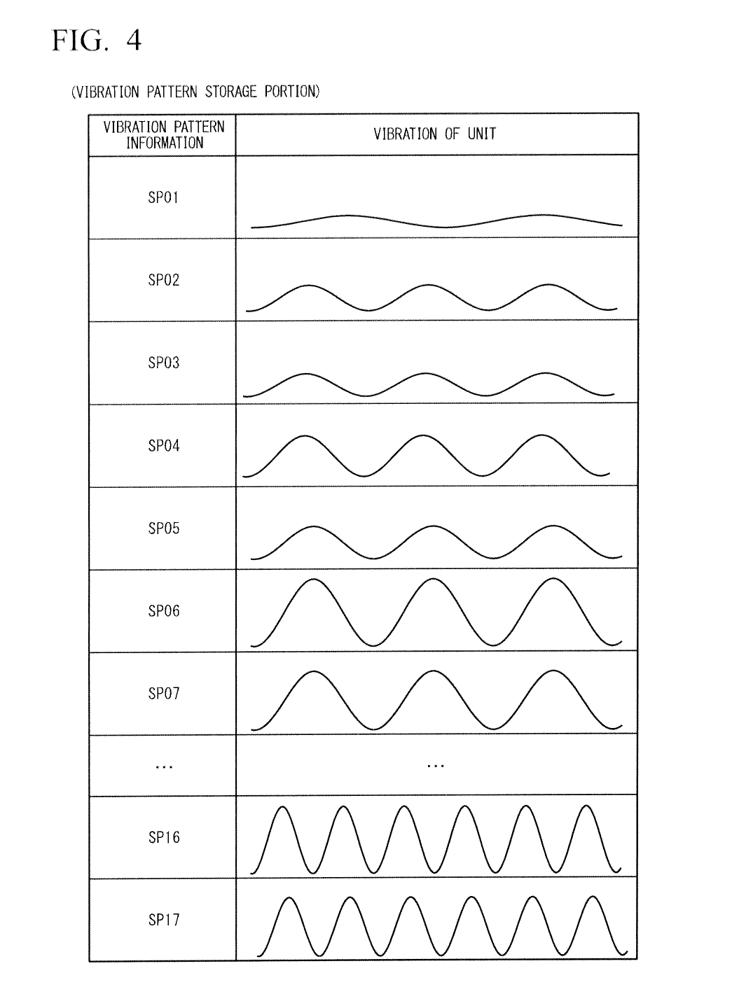

FIG. 4 is an explanatory diagram for explaining the vibration pattern information. In FIG. 4, each state is shown, of vibration of the body that occurs when each vibration pattern information is applied.

In FIGS. 3A and 3B, “Men (S=1)” as an item of Gender indicates vibration pattern information (SP01, SP02, SP04, SP06, SP12, SP14, SP16) used for a motion of male. In FIGS. 3A and 3B, “Women (S=2)” as an item of Gender indicates vibration pattern information (SP01, SP03, SP05, SP07, SP13, SP15, SP17) used for a motion of female.

In FIGS. 3A and 3B, “Baby (A=1)” as an item of Age Range indicates vibration pattern information (SP01) used for a motion of baby. “Kindergartener (A=2)” as an item of Age Range indicates vibration pattern information (SP02, SP03, SP12, SP13) used for a motion of kindergartener. “Elementary School Student (A=3)” as an item of Age Range indicates vibration pattern information (SP04, SP05, SP14, SP15) used for a motion of elementary school student. “More than Junior High School Student (Adult) (A=4)” as an item of Age Range indicates vibration pattern information (SP06, SP07, SP16, SP17) used for a motion of more than junior high school student (including adult).

The vibration pattern information of walking motion of baby is set to SP01 regardless of gender (refer to FIG. 3A). In addition, the vibration pattern information of running motion of baby is not specified (refer to FIG. 3B).

Each vibration pattern information is used for generating, on the body, sound and/or vibration that may occur in each motion, or vibration that represents sound/vibration recalled from each motion. In one example, the vibration pattern information “SP04” specified by index “Walk (B=1)-Men (S=1)-Elementary School Student (A=3)” is used for generating, on the body, sound and/or vibration that may occur when elementary school boy walks, or vibration that represents sound/vibration recalled from a motion in which an elementary school boy walks.

According to the vibration pattern information shown in FIGS. 3A, 3B and 4, for example, as shown by the difference in the amplitude of the vibration pattern information “SP02” and the vibration pattern information “SP04”, the vibration of the body based on the vibration pattern information applied in a case where Age Range (A) is high is greater than the vibration of the body based on the vibration pattern information applied in a case where Age Range (A) is low.

For example, as shown by the difference in the amplitude of the vibration pattern information “SP02” and the vibration pattern information “SP03”, the vibration of the body based on the vibration pattern information applied in a case where Gender (S) is male is greater than the vibration of the body based on the vibration pattern information applied in a case where Gender (S) is female.

For example, as shown by the difference in the frequency of the vibration pattern information “SP06” and the vibration pattern information “SP16”, the vibration of the body based on the vibration pattern information applied in a case of Running Motion (B) is faster than the vibration of the body based on the vibration pattern information applied in a case of Walking Motion (B).

The vibration pattern information storage portion 49 can store the vibration pattern information in advance (from the time of shipment), or can store the vibration pattern information registered (added) by the vibration pattern information updating portion 42. Furthermore, the vibration pattern information stored in the vibration pattern information storage portion 49 is updated (changed) or is deleted by the vibration pattern information updating portion 42.

The vibration pattern information updating portion 42 registers (adds), updates (changes), or deletes the vibration pattern information in the vibration pattern information storage portion 49. For example, in the vibration pattern information updating portion 42, the vibration pattern information received from an external portion via the communication portion 50 is associated with the index and registered in the vibration pattern information storage portion 49. In addition, in the vibration pattern information updating portion 42, the vibration pattern information generated by the vibration pattern information generating portion 41 is associated with the index and registered in the vibration pattern information storage portion 49.

The vibration pattern information generating portion 41 generates the vibration pattern information based on the sound in the moving image stored in the image storage portion 90. Specifically, the vibration pattern information generating portion 41 extracts the sound rhythm (pitch) from the moving image (video+audio) stored in the image storage portion 90. For example, the vibration pattern information generating portion 41 extracts the running rhythm of the kindergartener (boys) from the audio part (for example, the footsteps that the kindergartener (boys) runs) of the moving image (video+audio) captured the race of the kindergarten of athletic meet.

Then, the vibration pattern information generating portion 41 generates the vibration pattern information to vibrate the body so as to fit the extracted rhythm as the vibration pattern information of the specific index (Motion (B)-Gender (S)-Age Range (A)). For example, the vibration pattern information generating portion 41 generates the vibration pattern information to vibrate the body so as to fit the running rhythm of the kindergartener (boys) as the vibration pattern information indicating that the kindergartener (boys) is running (SP12 of FIG. 3B).

The vibration pattern information generating portion 41 identities the index by the notification from the object extracting portion 45.

In other words, the vibration pattern information generating portion 41 outputs the moving image to the object extracting portion 45 when the rhythm is extracted from the moving image (movie). The object extracting portion 45 recognizes a person as an object from the video part of the moving image. Moreover, the object extracting portion 45 recognizes the person attribute and the motion (details will be described later) and notifies the recognized result (i.e., index) to the vibration pattern information generating portion 41.

From the above, the vibration pattern information generating portion 41 can recognize what index is corresponding to the vibration pattern information to be generated.

The object extracting portion 45 extracts an object from an image stored in the image storage portion 90.

Specifically, when the vibration pattern information generating portion 41 extracts the rhythm (in other words, at the time of generation of the vibration pattern information), the object extracting portion 45 extracts the person from the video part of the moving image read from the image storage portion 90 as an object. Moreover, the object extracting portion 45 recognizes the person attribute and the person's motion (in other words, the object extracting portion 45 recognizes the index of the vibration pattern information). Then, the object extracting portion 45 outputs the index that is the recognized result to the vibration pattern information generating portion 41.

When the object extracting portion 45 recognizes the person attribute and the person motion that are not registered as an index in the vibration pattern information storage portion 49, the object extracting portion 45 can output the screen to be registered a new index to the user on the display portion 20 and can notify the index (for example, the motion of the kindergartener that is spinning round and round) that is input via the operation portion 10 to the vibration pattern information generating portion 41.

In addition, the object extracting portion 45, in addition to the time of generation of the vibration pattern information, also at the time of reproduction, extracts an object from an image stored in the image storage portion 90.

Specifically, the object extracting portion 45, at the time of reproduction, extracts the person as an object from the reproduced image that is read from the image storage portion 90 (still images/moving images). Moreover, the object extracting portion 45 recognizes the person attribute and the person's motion (index of the vibration pattern information). Then, the object extracting portion 45 outputs the index that is the recognized result to the vibration pattern information selection portion 46 together with the reproduced image that is read from the image storage portion 90.

The vibration pattern information selection portion 46, at the time of reproduction, selects the vibration pattern information corresponding to the object that is obtained from the object extracting portion 45 from the vibration pattern information storage portion 49. In more detail, the vibration pattern information selection portion 46 selects the vibration pattern information corresponding to the index that is obtained from the object extracting portion 45 from the vibration pattern information storage portion 49.

The vibration pattern information selection portion 46 that selects the vibration pattern information outputs this vibration pattern information as the vibration control information to the output control portion 60 together with the reproduced image that is obtained from the object extracting portion 45.

If the selected vibration pattern information is modified (processed) by the selected vibration pattern information correction portion 47, the vibration pattern information selection portion 46 outputs the vibration pattern information after correction as the vibration control information to the output control portion 60 together with the reproduced image that is obtained from the object extracting portion 45.

The selected vibration pattern information correction portion 47, in accordance with a predetermined condition, modifies the selected vibration pattern information (that is, the vibration pattern information which the vibration pattern information selection portion 46 selected from the vibration pattern information storage portion 49).

Specifically, the selected vibration pattern information correction portion 47 modifies the vibration pattern information that the vibration pattern information selection portion 46 selects according to movement (motion) of the object that is extracted by the object extracting portion 45.

For example, the selected vibration pattern information correction portion 47 obtains the index with the reproduced image (the moving image) from the object extracting portion 45. Next, the selected vibration pattern information correction portion 47 calculates the cycle of motion of the object (in other words, people) indicated by the index obtained from the object extracting portion 45. If the cycle is equal to or greater than a predetermined threshold value, the selected vibration pattern information correction portion 47 increases the frequency of the vibration pattern information selected by the vibration pattern information selection portion 46.

The selected vibration pattern information correction portion 47 can hold the threshold value to be compared with the cycle for each index. Moreover, the selected vibration pattern information correction portion 47 can hold a plurality of the above threshold values according to the increase amount of the frequency for each index.

The selected vibration pattern information correction portion 47 can modify the vibration pattern information selected by the vibration pattern information selection portion 46 according to the distance to the object extracted by the object extracting portion 45, in addition to or alternatively to the object extracted by the object extracting portion 45.

For example, the selected vibration pattern information correction portion 47 obtains the index with the reproduced image (the moving image or the still image) from the object extracting portion 45. Next, if the distance to the object indicated by the index obtained from the object extracting portion 45 is less than the predetermined threshold value, the selected vibration pattern information correction portion 47 increases the amplitude of the vibration pattern information selected by the vibration pattern information selection portion 46.

The selected vibration pattern information correction portion 47 can hold the threshold value to be compared with the distance for each index. Moreover, the selected vibration pattern information correction portion 47 can hold a plurality of the above threshold value according to the increase amount of the amplitude for each index.

Moreover, the selected vibration pattern information correction portion 47 can obtain the distance to the object, based on the additional information added to the reproduced image.

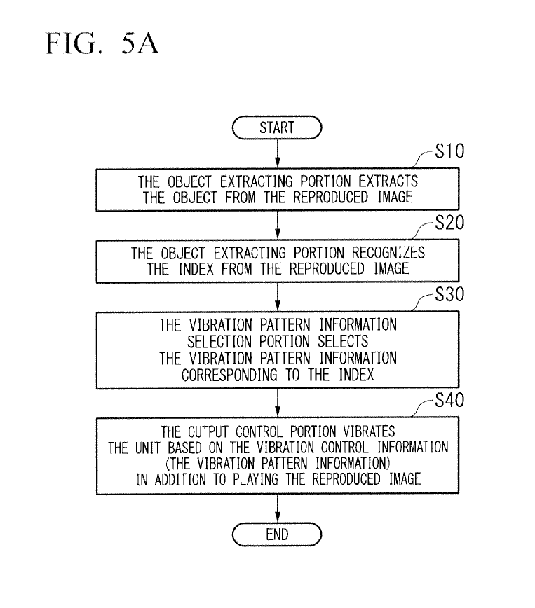

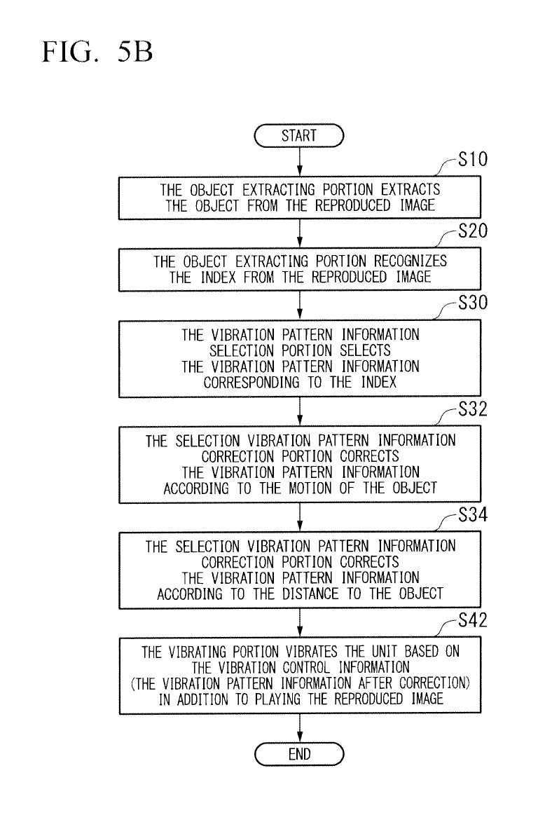

FIGS. 5A and 5B are an example of a flowchart showing a flow of processing of the electronic device 1. The flowchart of FIG. 5A is one example of the flow of processing of the electronic device at the time of reproduction. The process can starts when there is instructions from the user about the reproduction. In the flowchart of FIG. 5A, it is assumed that the user specifies the moving image, which is stored in the image storage portion 90, of the kindergartener (boys) who is running (video audio) as the reproduction image. That is similar to that for the flowchart of FIG. 5B.

In FIG. 5A, the object extracting portion 45 extracts a person as the object from the reproduced image read from the image storage portion 90 (Step S10). Next, the object extracting portion 45 recognizes the attributes of the person that extracted as the object and the person's motion that extracted as the object. That is, the object extracting portion 45 recognizes the index of the vibration pattern information from the reproduced image read from the image storage portion 90 (Step S20).

Specifically, the object extracting portion 45 extracts the object (the kindergartener (boys)) from the moving image in which the kindergartener (boys) is running as the object (Step S10). Then, the object extracting portion 45 recognizes the person attribute “Kindergartener (boys)” extracted as the object and the person's motion “Run” extracted as the object. In other words, the object extracting portion 45 recognizes the index “Run (B=2)-Men (S=1)-Kindergartener (A=2)” of the vibration pattern information from the moving image that the kindergartener (boys) is running (Step S20).

Next, the object extracting portion 45 outputs the index of the recognition result to the vibration pattern information selection portion 46 with the reproduced image read from the image storage portion 90.

The vibration pattern information selection portion 46 selects the vibration pattern information corresponding to the index that is obtained from the object extracting portion 45 from the vibration pattern information storage portion 49 (Step S30). Next, the vibration pattern information selection portion 46 outputs to the output control portion 60 this vibration pattern information as the vibration control information, along with the reproduced image obtained from the object extracting portion 45.

Specifically, the vibration pattern information selection portion 46 selects the vibration pattern information “SP12” corresponding to the index “Run (B=2)-Men (S=1)-Kindergartener (A=2)” obtained from the object extracting portion 45 from the vibration pattern information storage portion 49 (Step S30). Then, the vibration pattern information selection portion 46 outputs the output control portion 60 as the vibration control information with the reproduced image (the moving image that the kindergartener (boys) is running).

Then, the output control portion 60 controls to play the reproduced image and to vibrate the body on the basis of the vibration control information (Step S40).

Specifically, the display control portion 62 controls the output to the display portion 20 for the video part of the moving image, which is obtained from the vibration pattern information selection portion 46, of the kindergartener (boys) who is running. The sound control portion 64 controls the output to the speaker 16 for the audio portion of the above moving image. The vibration control portion 66 vibrates the vibrating portion 22 on the basis of the vibration control information obtained from the vibration pattern information selection portion 46 along with the above moving image (Step S40). Then, the flowchart of FIG. 5A is completed.

As described above, the electronic device 1, at the time of the reproduction of the image (at the time of display/audio output), generates the vibration control information and vibrates the body. Specifically, the electronic device 1 generates the vibration control information (selects the vibration pattern information) corresponding to the object (the attribute of the object, the type of motion of the object) extracted from the reproduced image. The electronic device 1 vibrates the body based on the generated vibration control information.

In the case of the flowchart of FIG. 5A, the electronic device 1 utilized directly the vibration pattern information as the vibration control information. However, the electronic device 1 can modify (process) the vibration pattern information and can utilize the vibration pattern information after correction as the vibration control information.

The flowchart of FIG. 5B is an example of a flow of processing when correcting the vibration pattern information selected from the vibration pattern information storage portion 49 and outputting the vibration pattern information after the correction to the output control portion 60 as the vibration control information. In addition, since Step S10, S20, and S30 in FIG. 5B are similar to those in the flowchart in FIG. 5A, the description thereof will be omitted here completely or in part.

In the flowchart of FIG. 5B, following the Step S30, the selected vibration pattern information correction portion 47 corrects the vibration pattern information selected by the vibration pattern information selection portion 46 according to the motion of the object extracted by the object extracting portion 45 (Step S32).

Specifically, the selected vibration pattern information correction portion 47 obtains the index from the object extracting portion 45 with the reproduced image. Then, the selected vibration pattern information correction portion 47 calculates the period of the motion of the object (i.e., person (human)) indicated by the index obtained from the object extracting portion 45. Moreover, if the period is equal to or greater than a predetermined threshold value, the selected vibration pattern information correction portion 47 corrects the vibration pattern information selected in Step S30.

Next to the Step S32, the selected vibration pattern information correction portion 47 corrects the vibration pattern information (the vibration pattern information after the correction when it is corrected in Step S32) selected in Step S30 according to the distance to the above object (Step S34).

Specifically, if the distance to the object is less than a predetermined threshold value, the selected vibration pattern information correction portion 47 corrects the vibration pattern information selected in Step S30 or further corrects the vibration pattern information corrected according to the motion of the object in Step S32.

If the selected vibration pattern information correction portion 47 has corrected the vibration pattern information in Step S32 or in Step S34, the vibrating portion 22 vibrates the body based on the vibration pattern information after correction (the vibration control information) (Step S42). Then, the flowchart of FIG. 5B is completed.

As described above, in the case of FIG. 5B, the electronic device 1 generates (selects and modifies the vibration pattern information) the vibration control information corresponding to the object (the attribute of the object (for example, the kindergartener (boys)), the type of motion of the object (for example, run), the period of motion of the object, the distance to the object) extracted from the reproduced image and vibrates the body based on the vibration control information generated.

When the electronic device 1 plays the moving image, the electronic device 1 can generate the vibration control information corresponding to the object extracted from the frame of the each reproduced image and can also be changed the vibration of the body every time. Namely, in the flowchart shown in FIGS. 5A, 5B, until the playback of the image that the playback instruction from the user has been performed finish, the electronic device 1 can repeatedly execute Step S10 to Step S40 (S42).

As described above, the electronic device 1 can vibrate the body in accordance with the display image. Specifically, the electronic device 1 can generate the vibration control information corresponding to the display content (specifically, the object) during the playback of the images (the captured still image, the received still image, the captured moving image, and the received moving image) stored in the image storage portion 90 and can provide the vibration to the body based on the vibration control information.

As shown by the broken line in FIG. 2, the electronic device 1 can vibrate the body in accordance with the display image (the display content) during streaming playback of the image (the received still image, the received moving image) received from the outside through the communication portion 50.

### The Second Embodiment

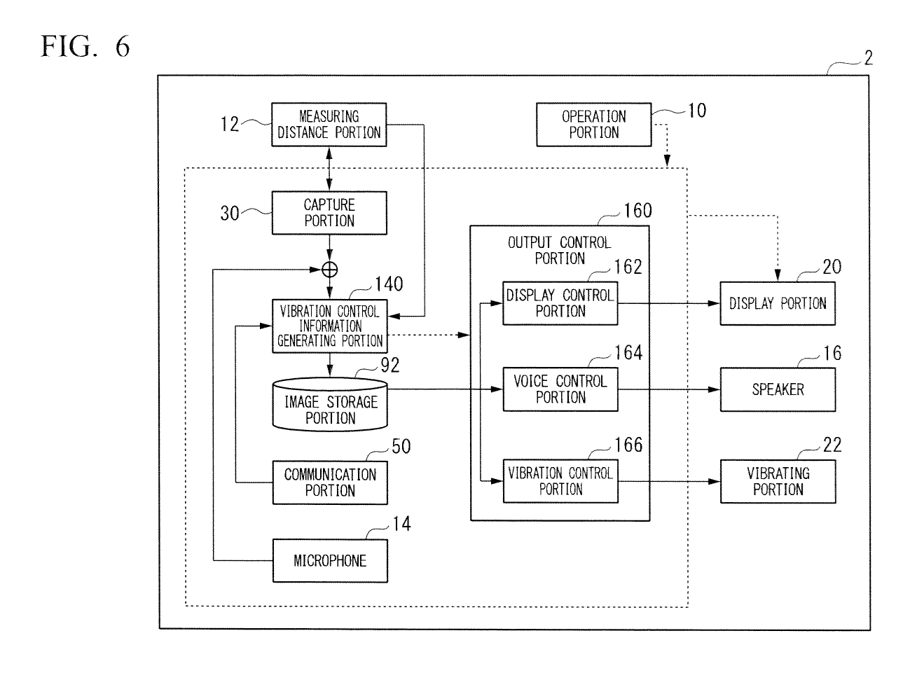

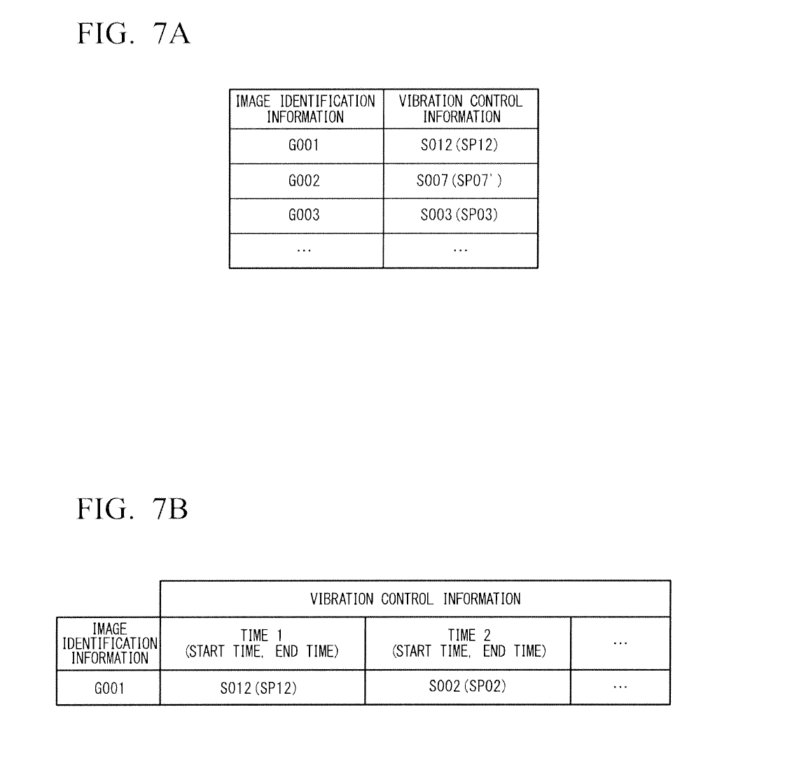

FIG. 6 is an example of a functional block diagram of an electronic device 2 according to a second embodiment of the present invention. FIGS. 7A and 7B are an example of information stored in the image storage portion 92. The electronic device 2 generates the vibration control information at the time of capture.

The electronic device 2, as shown in FIG. 6, includes an operation portion 10, a measuring distance portion 12, a microphone 14, a speaker 16, a display portion 20, a capture portion 30, a vibration control information generating portion 140, a communication portion 50, an output control portion 160, and, an image storage portion 92. The output control portion 160 includes a display control portion 162, a sound control portion 164, and a vibration control portion 166.

Since the operation portion 10, the measuring distance portion 12, the microphone 14, the speaker 16, the display portion 20, the capture portion 30, and the communication portion 50 provided in the electronic device 2 are similar to the operation portion 10, the measuring distance portion 12, the microphone 14, the speaker 16, the display portion 20, the capture portion 30, and the communication portion 50 provided in the electronic device 1 according to the first embodiment, part or all of the description of the elements will be omitted.

The vibration control information generating portion 140 extracts the object from the captured image (the still images/the moving images) and generates the vibration control information according to the extracted object, during current imaging by the capture portion 30. In addition, the vibration control information generating portion 140 stores the vibration control information generated as described above in the image storage portion 92 in correspondence with the captured image. In addition, details of the vibration control information generating portion 140 will be described later.

The image storage portion 92 stores such as the still image (the captured still image, the received still image), the moving image (the captured moving image, the received moving image), and the sound (the recording sound, the received sound) as well as the image storage portion 90 provided in the electronic device 1 according to the first embodiment.

In addition, the image storage portion 92 stores the vibration control information generated by the vibration control information generating portion 140. Specifically, as shown in FIG. 7A, in the image storage portion 92, the vibration control information is associated with the image identification information (for example, the image file name), which is for identifying the image (the captured still image, the captured moving image), and stored.

In the example shown in FIG. 7A, the image storage portion 92 stores the vibration control information “S012” in association with the image identification information “G001” of one captured moving image. The image storage portion 92 stores the vibration control information “S007” in association with the image identification information “G002” of another captured moving image. The image storage portion 92 stores the vibration control information “S003” in association with the image identification information “G003” of one captured still image.

In FIG. 7A, the vibration control information “S012 (SP12)” represents that the vibration control information “S012” is the vibration pattern information “SP12”. This also applies to the vibration control information “S003 (SP03)”. The vibration control information “S007 (SP07′)” represents that the vibration control information “S007” is “SP07′” modified by the vibration pattern information “SP07”.

In example of FIG. 7A, the image storage portion 92 is an example of storing one of the vibration control information for one image. However, as shown in FIG. 7B, the image storage portion 92 can store the plurality of the vibration control information for one image (the captured moving image). For example, in the example shown in FIG. 7B, the image storage portion 92 can store the vibration control information for each time in association with the image identification information “G001” of one captured moving image.

In FIG. 7B, the image storage portion 92 stores the vibration control information “S012” in association with the time 1 (for example, during 5 seconds of after 5 seconds to 10 seconds from the capturing start time) for the captured moving image. of the image identification information “G001”. The image storage portion 92 stores the vibration control information “S002” in association with the time 2 (for example, during 3 seconds of after 12 seconds to 15 seconds from the capturing start time).

Specifically, for example, when the capture portion 30 captures the scene that the kindergartener (boys) is running in 5 seconds of after 5 seconds to 10 seconds from the capturing start time and captures the scene that the kindergartener (boys) is walking in 3 seconds of after 12 seconds to 15 seconds from the capturing start time, the vibration control information generating portion 140 generates (selects) the vibration control information “S012 (SP12)” based on the above-described 5 seconds parts, generates (selects) the vibration control information “S002 (SP02)” based on the above-described 3 seconds parts, and stores in the image storage portion 92 in association with the time 1 and the time 2 respectively as shown in FIG. 7B based on the vibration pattern information (refer to FIGS. 3A, 3B) in the vibration pattern information storage portion 149 (described later)

The display control portion 162 controls the output to the display portion 20 of the image stored in the image storage portion 92 (the still images/the moving images). The display portion 20 displays the image stored in the image storage portion 92 according to the control of the display control portion 162. In addition, the display control portion 162 can control the output to the display portion 20 with respect to the through image that is generated by the capture portion 30.

The sound control portion 164 controls the output to the speaker 16 of the sound (including sound portion of the moving image) stored in the image storage portion 92. The speaker 16 outputs the sound stored in the image storage portion 92 according to the control of the sound control portion 164.

The vibration control portion 166 vibrates the vibrating portion 22 based on the vibration control information read from the image storage portion 92. The vibrating portion 22 vibrates the body according to the control of the vibration control portion 166. In other words, the vibrating portion 22 vibrates the body based on the vibration control information generated by the vibration control information generating portion 140, during current imaging by the capture portion 30.

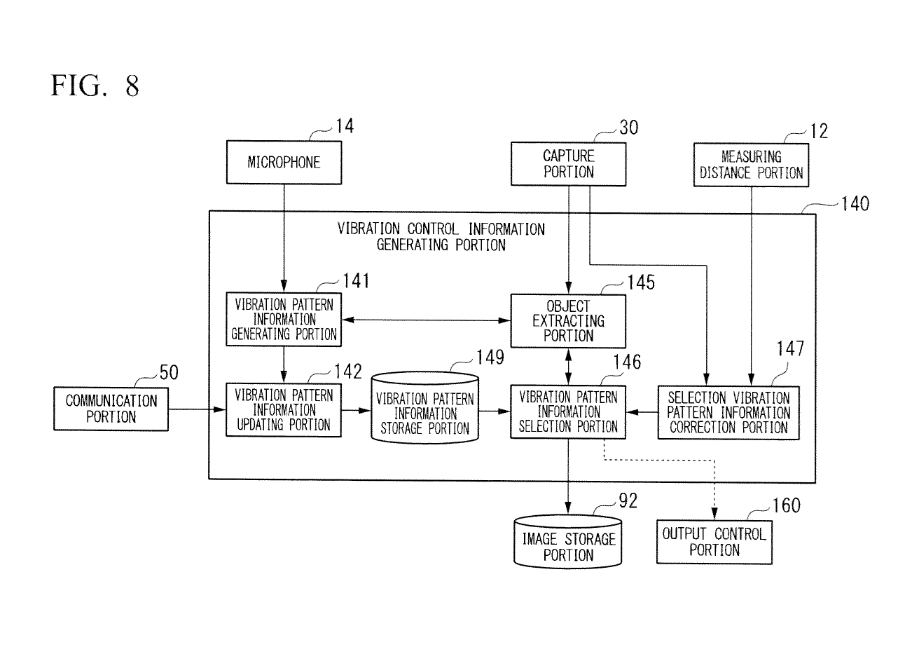

FIG. 8 is an example of a functional block diagram of the vibration control information generating portion 140. As shown in FIG. 8, the vibration control information generating portion 140 includes the vibration pattern information generating portion 141, the vibration pattern information updating portion 142, the object extracting portion 145, the vibration pattern information selection portion 146, the selected vibration pattern information correction portion 147, and the vibration pattern information storage portion 149.

The vibration pattern information storage portion 149 stores the predetermined vibration pattern information of each object as well as the vibration pattern information storage portion 49 provided in the electronic device 1 according to the first embodiment. In other words, as shown in FIGS. 3A, 3B and FIG. 4, the vibration pattern information storage portion 149 stores the predetermined vibration pattern information of each object.

The vibration pattern information updating portion 142 registers (adds), updates (changes), or deletes the vibration pattern information in the vibration pattern information storage portion 149 as well as the vibration pattern information updating portion 42 provided in the electronic device 1 according to the first embodiment.

The vibration pattern information generating portion 141, at the time of capture, generates the vibration pattern information based on the sound output from the microphone 14.

Specifically, the vibration pattern information generating portion 141 extracts the sound rhythm (pitch) as well as the vibration pattern information generating portion 41 provided in the electronic device 1 according to the first embodiment based on the user instruction (for example, at the time of capture, the instruction for generating the vibration pattern information) input via the operation portion 10. The vibration pattern information generating portion 141 generates the vibration pattern information to vibrate the body so as to fit the extracted rhythm, as the vibration pattern information of the specific index “Motion (B)-Gender (S)-Age Range (A)”.

The vibration pattern information generating portion 141 identifies the index by the notification from the object extracting portion 145 as well as the vibration pattern information generating portion 41.

The object extracting portion 145, at the time of capture, extracts the object from the captured image. Specifically, when the vibration pattern information generating portion 141 extracts the rhythm (in other words, at the time of generation of the vibration pattern information), the object extracting portion 145 extracts a person as an object from the captured image. Furthermore, the object extracting portion 145 recognizes the person attributes and the person's motion (in other words, recognizes the index of the vibration pattern information). Then, the object extracting portion 145 outputs the index of the recognition result to the vibration pattern information generating portion 141.

When the object extracting portion 145 recognizes the person attributes and the person's motion that are not registered as the index in the vibration pattern information storage portion 149, the object extracting portion 145 can output the screen to register a new index to the user to the display portion 20 and can notify the index input via the operation portion 10 to the vibration pattern information generating portion 141.

The object extracting portion 145, at the time of capture, extracts a person as an object from the captured image based on the user instruction input via the operation portion 10 (for example, at the time of capture, the instruction for generating the vibration control information). Furthermore, the object extracting portion 145 recognizes the person attributes and the person's operation (in other words, recognizes the index of the vibration pattern information). Then, the object extracting portion 145 outputs the index of the recognition result to the vibration pattern information selection portion 146 with the captured image.

The vibration pattern information selection portion 146, at the time of capture (imaging), selects the vibration pattern information corresponding to the object obtained from the object extracting portion 145 from the vibration pattern information storage portion 149 as well as the vibration pattern information selection portion 46 provided in the electronic device 1 according to the first embodiment. In other words, the vibration pattern information selection portion 146 selects the vibration pattern information corresponding to the index obtained from the object extracting portion 145 from the vibration pattern information storage portion 149.

As shown in FIGS. 7A and 7B, the vibration pattern information selection portion 146 that selects the vibration pattern information stores (writes) this vibration pattern information in the image storage portion 92 in association with the captured image (the image identification information) obtained from the object extracting portion 145 as the vibration control information.

If the selected vibration pattern information has been modified (processed) by the selected vibration pattern information correction portion 147, the vibration pattern information selection portion 146 stores the vibration pattern information after correction in the mage storage portion 92 in association with the captured image obtained from the object extracting portion 145 as the vibration control information.

The selected vibration pattern information correction portion 147 modifies the selected vibration pattern information according to a predetermined condition (i.e., the vibration pattern information that the vibration pattern information selection portion 146 selects from the vibration pattern information storage portion 149 according to a predetermined condition).

Specifically, the selected vibration pattern information correction portion 147 corrects the vibration pattern information selected by the vibration pattern information selection portion 146 according to the motion of the object extracted by the object extracting portion 145 as well as the selected vibration pattern information correction portion 47 provided in the electronic device 1 according to the first embodiment. The selected vibration pattern information correction portion 147 can modify the vibration pattern information selected by the vibration pattern information selection portion 146 according to the distance to the object extracted by the object extracting portion 145 as well as the selected vibration pattern information correction portion 47.

The selected vibration pattern information correction portion 147 can obtain the distance to the object from the additional information added in the captured image as well as the selected vibration pattern information correction portion 47 provided in the electronic device 1 according to the first embodiment. Alternatively, the selected vibration pattern information correction portion 147 can directly obtain the distance value from the measuring distance portion 12.

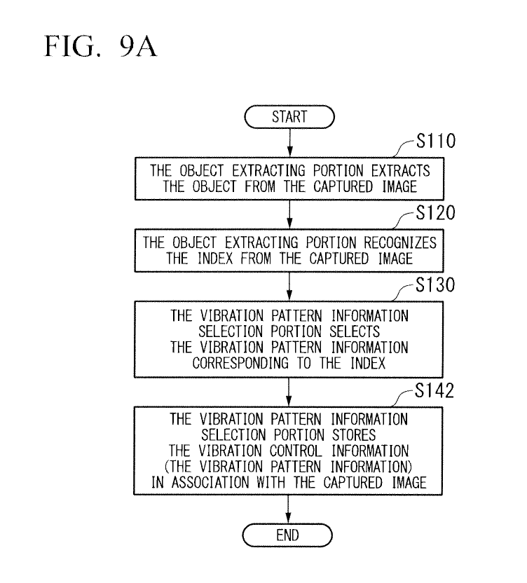

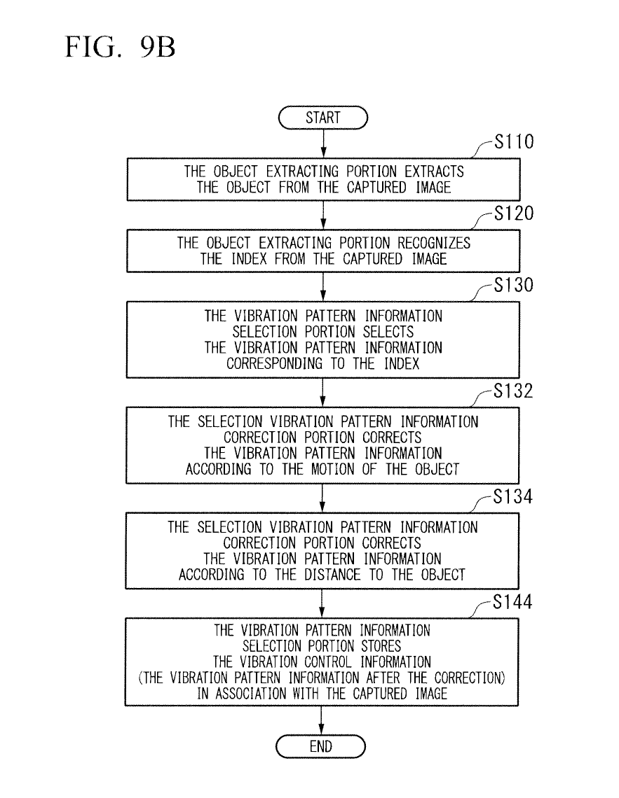

FIGS. 9A and 9B are an example of a flowchart showing a flow of processing of the electronic device 2. The flowchart of FIG. 9A is one example of the flow of processing of the electronic device at the time of capture. The process can star when there is instructions from the user about the capturing. In the flowchart of FIG. 9A, it is assumed that the moving image of the kindergartener (boys) who is running (video+audio) is captured. That is similar to that for the flowchart of FIG. 9B.

In FIG. 9A, the object extracting portion 145 extracts a person as the object from the captured image output from the capture portion 30 (Step S110). Next, the object extracting portion 145 recognizes the attributes of the person that extracted as the object and the person's motion that extracted as the object. That is, the object extracting portion 145 recognizes the index of the vibration pattern information from the captured image (Step S120).

Specifically, the object extracting portion 145 extracts the object (the kindergartener (boys)) from the moving image in which the kindergartener (boys) is running as the object (Step S110). Then, the object extracting portion 145 recognizes the person attribute “Kindergartener (boys)” extracted as the object and the person's motion “Run” extracted as the object. In other words, the object extracting portion 145 recognizes the index “Run (B=2)-Men (S=1)-Kindergartener (A=2)” of the vibration pattern information from the moving image that the kindergartener (boys) is running (Step S120).

Next, the object extracting portion 145 outputs the index of the recognition result to the vibration pattern information selection portion 146 with the captured image.

The vibration pattern information selection portion 146 selects the vibration pattern information corresponding to the index that is obtained from the object extracting portion 145 from the vibration pattern information storage portion 149 (Step S130). Next, the vibration pattern information selection portion 146 stores this vibration pattern information in the image storage portion 92 in association with the captured image (the image identification information) obtained from the object extracting portion 145 as the vibration control information (Step S142).

Specifically, the vibration pattern information selection portion 146 selects the vibration pattern information “SP 12” corresponding to the index “Run (B=2)-Men (S=1)-Kindergartener (A=2)” obtained from the object extracting portion 145 from the vibration pattern information storage portion 149 (Step S130).

Next, as shown in FIG. 7A, the vibration pattern information selection portion 146 stores the vibration pattern information “SP12” as the vibration control information “S012” in the image storage portion 92 in association with the image identification information (for example, G001) for identifying the captured image (the moving image the kindergartener (boys) is running) (Step S142).

Then, the flowchart of FIG. 9A is completed.

If the electronic device 2 has played the above image (the captured image of the image identification information “G001”) stored in the image storage portion 92 based on the reproduction instruction of the user, the output control portion 160 (the display control portion 162) controls the output to the display portion 20 for the video part of the reproduced image.

The output control portion 160 (the sound control portion 164) controls the output to the speaker 16 for the sound portion of the reproduced image. The output control portion 160 (the vibration control portion 166) vibrates the vibrating portion 22 based on the vibration control information “S012 (SP12)” stored in association with the reproduced image.

In other words, the electronic device 2 vibrates the body based on the vibration control information pre-generated at the time of capture during the reproduction of the image (at the time of display/audio output). Specifically, the electronic device 2 generates the vibration control information (selects the vibration pattern information) corresponding to the object (the attribute of the object, the type of motion of the object) extracted from the captured image. The electronic device 2 vibrates the body based on the generated vibration control information.

In addition, in the case of the flowchart of FIG. 9A, the electronic device 2 utilized directly the vibration pattern information as the vibration control information. However, the electronic device 2 can modify (process) the vibration pattern information and can utilize the vibration pattern information after correction as the vibration control information.

The flowchart of FIG. 9B is an example of a flow of processing when correcting the vibration pattern information selected from the vibration pattern information storage portion 149 and storing the vibration pattern information after the correction in the image storage portion 92 as the vibration control information. Since Step S110, S120, and S130 in FIG. 9B is similar to those of the flowchart in FIG. 9A, the description will be omitted partially or all.

In the flowchart of FIG. 9B, following the Step S130, the selected vibration pattern information correction portion 147 corrects the vibration pattern information selected by the vibration pattern information selection portion 146 according to the motion of the object extracted by the object extracting portion 145 (Step S132). The processing of the Step S132 is the same as the Step S32 in FIG. 5B.

Next to the Step S132, the selected vibration pattern information correction portion 147 corrects the vibration pattern information (the vibration pattern information after the correction when it is corrected in Step S132) selected in Step S130 according to the distance to the above object (Step S34). The processing of the Step S134 is the same as the Step S34 in FIG. 5B.

If the selected vibration pattern information correction portion 147 has corrected the vibration pattern information in Step S132 or in Step S134, the vibration pattern information selection portion 146 stores the vibration pattern information after the correction in the image storage portion 92 as the vibration control information (Step S144). Then, the flowchart of FIG. 9B is completed.

As described above, in the case of FIG. 9B, the electronic device 2 generates (selects and modifies the vibration pattern information) the vibration control information corresponding to the object (the attribute of the object, the type of motion of the object, the period of motion of the object, the distance to the object) extracted from the captured image and vibrates the body based on the vibration control information generated.

When the electronic device 2 captures the moving image, the electronic device 2 can generate the vibration control information corresponding to the object extracted from the frame of the each captured image and can store the moving image in the image storage portion 92 in association with the time, as shown in FIG. 7B. Namely, in the flowchart shown in FIGS. 9A, 9B, until the capturing by the user has been finished, the electronic device 2 can repeatedly execute Step S110 to Step S142 (S144).

As described above, the electronic device 2 can vibrate the body in accordance with the display image. Specifically, the electronic device 2 can generate the vibration control information corresponding to the capturing content (specifically, the object) when capturing by the capture portion 30 so as to store the vibration control information in the image storage portion 92, and can provide the body with the vibration based on the vibration control information during reproduction.

As shown by the broken line in FIG. 8, the electronic device 2 can output the vibration control information, which is generated at the time of imaging (capturing), to the output control portion 160. In other words, when the electronic device 2 performs the display of the through image, the electronic device 2 can vibrate the body. The electronic device 2, while the through image is displayed, for example, can modify the vibration control information (the vibration pattern information) and can dampen the vibration.

As described above, the electronic device 1 according to the first embodiment and the electronic device 2 according to the second embodiment can vibrate the body in accordance with the display image. That is, the user can obtain the sense of touch in addition to the sense of sight (or the sense of sight and the sense of hearing) during the reproduction of the moving image (or the still image).

The electronic device 1 (the electronic device 2) can generate a pseudo sound according to the extraction object in addition to the vibration control information. The pseudo sound is sound data output from the speaker 16 and can be assumed based on the attribute of the object, the motion of the object in the image.

For example, the electronic device 1 (the electronic device 2), as well as the vibration pattern information, can store the pseudo sound pattern information for each index in the vibration pattern information storage portion 49 (the vibration pattern information storage portion 149). The vibration pattern information selection portion 46 (the vibration pattern information selection portion 146) can select the pseudo sound pattern information corresponding to the index.

The electronic device 1 (the electronic device 2) extracts person as the object. Alternatively, the electronic device 1 (the electronic device 2) can extract other than the person as the object.

When the electronic device 1 (the electronic device 2), for example, extracts vehicle as the object, the vibration pattern information storage portion 49 (the vibration pattern information storage portion 149) stores the vibration pattern information (as well as the pseudo sound pattern information) for each type of vehicle (for example, light vehicle, sports car, bus, train, bullet train, helicopter, airplane). For example, when the electronic device 1 (the electronic device 2) extracts animal as the object, the vibration pattern information storage portion 49 (the vibration pattern information storage portion 149) stores the vibration pattern information (as well as the pseudo sound pattern information) for each type of the animal (for example, large dog, small dog, cat, bird (various types), insect (various types)).

Furthermore, by recording a program for executing each processes of the electronic device 1, 2 according to embodiments of the present invention in a computer readable recording medium, the various processes described above according to each processes of the electronic device 1, 2 according to embodiments of the present invention may be performed by loading and carrying out the program recorded on the recording medium into the computer system.

The “computer system” according to the present invention may include an OS and hardware such as peripheral devices. In addition, if the “computer system” is using a WWW system, the home page providing environment (or the display environment) is also meant to include. In addition, “the computer-readable recording medium” is the storage device such as a writable non-volatile memory such as floppy (registered trademark) disk, magneto-optical disk, SD card, flash memory, portable medium such as CD-ROM, hard disk incorporated in a computer system.

Furthermore, “the computer-readable recording medium” also includes recording medium that holds a program for a predetermined period of time as a volatile memory (for example, Dynamic Random Access Memory (DRAM)) inside the computer system serving as a server or client when the program is transmitted via a network such as the internet and the like or a communication line such as a telephone line and the like.

The above program may be transmitted to another computer system through a transmission medium or by a transmission wave in a transmission medium from the computer system that stores this program in a storage device or the like. Here, “the transmission medium” that transmits the program indicates a medium having a function for transmitting the information as the network such as the internet (communication network) or a telephone line such as a communication system (communication line).

In addition, the above program may be one for achieving the part of the function as described above. Furthermore, the above program may be one that can be achieved in combination with programs already recorded in the function as described above in the computer system, so-called differential file (differential program).

The embodiments of the present invention have been described above with reference to the drawings. However, the specific configuration is not limited to these embodiments. The present invention also includes other designs that do not depart from the scope of the inventions as stated in the attached claims.

1. An electronic device comprising:
a display portion configured to display an image;
a vibration portion configured to vibrate a body based on vibration control information; and
a vibration control information generating portion configured to extract an object from an image and to generate the vibration control information according to the extracted object.

2. The electronic device according to claim 1 further comprising:
an image storage portion configured to store an image, wherein
the vibration control information generating portion is configured to extract an object from the image stored in the image storage portion.

3. The electronic device according to claim 1, wherein
the vibration control information generating portion is configured to generate the vibration control information at a time of displaying an image by the display portion.

4. The electronic device according to claim 1 further comprising:
an imaging portion, wherein
the vibration control information generating portion is configured to extract an object from a captured image captured by the imaging portion at a time of imaging by the imaging portion.

5. The electronic device according to claim 4 further comprising:
the image storage portion configured to store an image, wherein
the vibration control information generating portion is configured to store the vibration control information, which is generated in response to the object extracted from the captured image and is associated with the captured image, in the image storage portion.

6. The electronic device according to claim 1, wherein
the vibration control information generating portion stores predetermined vibration pattern information for each object and is configured to generate the vibration control information based on the vibration pattern information corresponding to the object extracted from an image.

7. The electronic device according to claim 6, wherein
the vibration control information generating portion is configured to correct the vibration pattern information, which corresponds to an object extracted from an image, according to a motion of the object and to generate the vibration control information.

8. The electronic device according to claim 6, wherein
the vibration control information generating portion is configured to correct the vibration pattern information, which corresponds to an object extracted from an image, according to a distance to the object and to generate the vibration control information.

9. The electronic device according to claim 6, wherein
the vibration control information generating portion is configured to generate the vibration pattern information based on a sound on a moving image.

10. The electronic device according to claim 1, wherein
the vibration control information generating portion is configured to extract an object for a person from the image and to generate the vibration control information corresponding to an attribute of the person as the extracted object.

11. The electronic device according to claim 1, wherein
the vibration control information generating portion is configured to generate a pseudo sound corresponding to the object extracted from an image.
